(19) United States
(12) Patent Application Publication
(10) Pub. No.: US 2025/0160426 A1
(43) Pub. Date: May 22, 2025

(54) DEVICE AND METHOD FOR CONTROLLING THE SAME

(71) Applicant: KT&G CORPORATION, Daejeon (KR)

(72) Inventor: Moonbong LEE, Seoul (KR)

(73) Assignee: KT&G CORPORATION, Daejeon (KR)

(21) Appl. No.: 18/834,924

(22) PCT Filed: Feb. 1, 2023
(86) PCT No.: PCT/KR2023/001460

§ 371 Date: Jul. 31, 2024

(30) Foreign Application Priority Data
Feb. 8, 2022 (KR) 10-2022-0016328

(51) Int. Cl. A24F 40/51; A24F 40/20; A24F 40/46

(52) U.S. Cl. CPC A24F 40/51; A24F 40/20; A24F 40/46

(57) ABSTRACT

A device is provided. The device includes: a body comprising an insertion space; an electrode disposed adjacent to the insertion space; and a controller configured to control the electrode to heat a cigarette inserted into the insertion space by dielectric heating at a predetermined frequency to reduce a moisture content of the cigarette.

### TECHNICAL FIELD

The present disclosure relates to a device such as an aerosol generating device, a cigarette case, or the like that receives or accommodates a stick containing a medium.

### BACKGROUND ART

An aerosol generating device, which is one example of a device, is used to extract certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to provide a device that can dry a stick to reduce the moisture content of the stick, and a method for controlling the device.

It is yet another objective of the present disclosure to selectively remove moisture from a stick while leaving a substance, such as glycerin, included in a medium of the stick.

It is yet another objective of the present disclosure to prevent a change in the taste of a stick.

### Solution to Problem

According to one aspect of the subject matter described in this application, a device includes: a body comprising an insertion space; an electrode disposed adjacent to the insertion space; and a controller configured to control the electrode to heat a cigarette inserted into the insertion space by dielectric heating at a predetermined frequency to reduce a moisture content of the cigarette.

### Advantageous Effects of Invention

According to at least one of the embodiments of the present disclosure, a device that dries a stick to reduce the moisture content of the stick, and a method for controlling the device may be provided.

According to at least one of the embodiments of the present disclosure, moisture may be selectively removed from a stick while leaving a substance, such as glycerin, included in a medium of the stick.

According to at least one of the embodiments of the present disclosure, a change in the taste of a stick may be prevented.

The additional scope of applicability of the present disclosure will be apparent from the following detailed description. However, those skilled in the art will appreciate that various modifications and alterations are possible, without departing from the idea and scope of the present disclosure, and therefore it should be understood that the detailed description and specific embodiments, such as the preferred embodiments of the present disclosure, are provided only for illustration.

### BRIEF DESCRIPTION OF DRAWINGS

FIGS. 1 to 8 illustrate examples of an aerosol generating device according to embodiments of the present disclosure.

### BEST MODE FOR CARRYING OUT THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

Hereinafter, a ‘device’ may refer to an aerosol generating device 100 or a cigarette case 300 described later. However, this is just an example, and the device is not limited thereto. Any device that receives a cigarette therein may be employed.

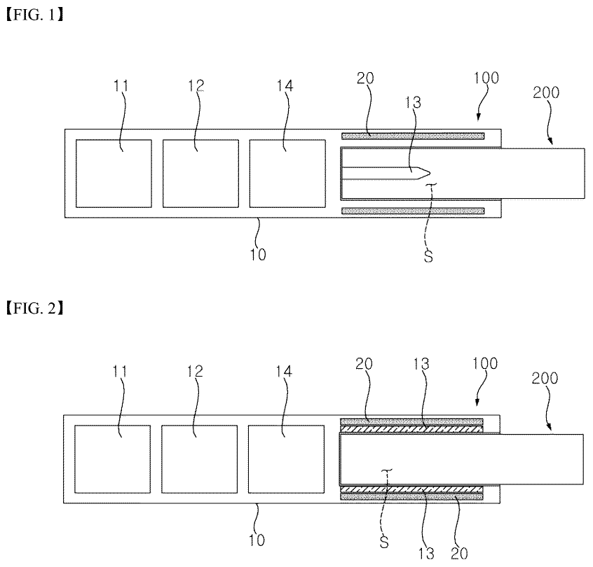

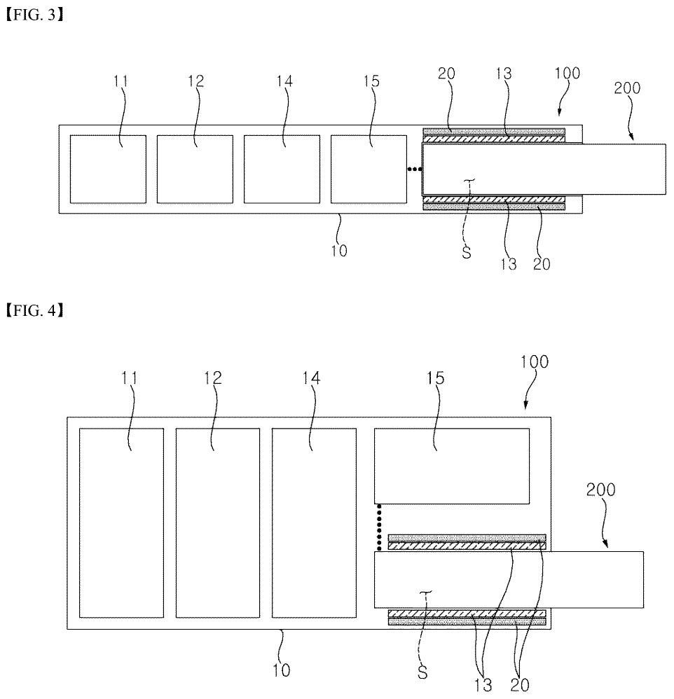

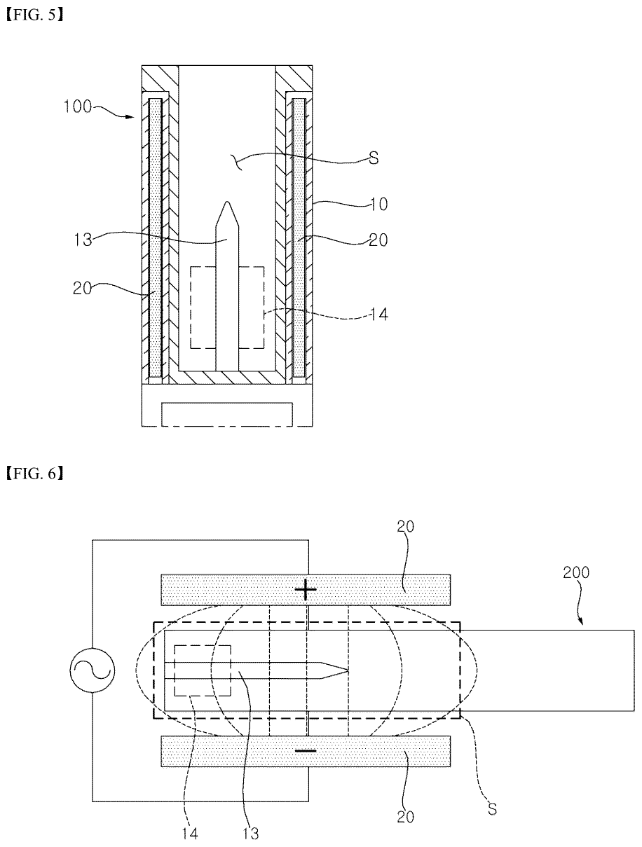

An aerosol generating device 100 will be described with reference to FIGS. 1 to 4. The device may be the aerosol generating device 100. Referring to FIGS. 1 and 2, the aerosol generating device 100 may include at least one of a battery 11, a controller 12, and a heater 13. The aerosol generating device 100 may further include a sensor 14. Referring to FIGS. 3 and 4, the aerosol generating device 100 may further include a cartridge 15.

Referring to FIGS. 1 and 2, the battery 11, the controller 12, and the heater 13 may be arranged in a row. Referring to FIG. 3, the battery 11, the controller 12, the heater 13, and the cartridge 14 may be arranged in a row. Referring to FIG. 4, the cartridge 15 and the heater 13 may be arranged in parallel to face each other. The internal structure of the aerosol generating device 100 is not limited to those shown in the drawings.

The aerosol generating device 100 may provide an insertion space S. The insertion space S may be open toward the top of the aerosol generating device 100. The insertion space S may have a cylindrical shape. A stick 200 may be inserted into the insertion space S. The insertion space S may have a shape corresponding to a lower portion of the stick 200. A single stick 200 may be inserted into the insertion space S. The stick 200 may be exposed to an outside of the aerosol generating device 100 from the insertion space S. The stick 200 may include a medium therein. The stick 200 may be referred to as a cigarette 200. The medium may contain glycerin.

The heater 13 may be disposed around the insertion space S or in the insertion space S. The heater 13 may heat the insertion space S and the stick 200 inserted into the insertion space S. The heater 13 may heat the stick 200 to burn the medium in the stick 200, thereby generating an aerosol. The heater 13 may be an electrically resistive heater. The heater 13 may be made of a conductive metal. The heater 13 may generate heat directly using a current supplied from the battery 11. Alternatively, an induction coil (not shown) may be wound around the heater 13, and the heater 13 may generate heat by a magnetic field produced by an AC current flowing through the induction coil (not shown). The magnetic field may pass through the heater 13 to generate an eddy current in the heater 13, and the current may cause heat to be generated in the heater 13.

Referring to FIG. 1, the heater 13 may protrude upward from a bottom of the insertion space S. The heater 13 may have an elongated rod shape. The heater 13 may have a pointed or sharp upper end. When the stick 200 is inserted into the insertion space S, the heater 13 may be inserted into the stick 200, and the heater 13 may heat the medium in the stick 200. When the stick 200 is heated, the medium may be burned to generate an aerosol.

Referring to FIGS. 2 to 4, the heater 13 may surround the insertion space S. When the stick 200 is inserted into the insertion space S, the heater 13 may surround the lower portion of the stick 200. The heater 30 may extend in a circumferential direction along a circumference of the insertion space S. The heater 30 may have a ring shape or a cylindrical shape. When the stick 200 is inserted into the insertion space S, the heater 13 may surround a lower outer circumferential surface of the stick 200 and may heat the lower outer circumferential surface of the stick 200. When the stick 200 is heated, the medium in the stick 200 may be burned to generate an aerosol. The heater 200 may be disposed at a height corresponding to a medium portion in the stick 200. FIGS. 3 and 4 illustrate that the heater 13 is included in the aerosol generating device 100, but, if necessary, the heater 13 may be excluded.

The cartridge 15 may store a liquid therein. The cartridge 15 may generate an aerosol through the liquid stored therein. The cartridge 15 may include a wick supplied with the liquid stored therein. The cartridge 15 may include a heater that heats the wick to generate the aerosol. The heater of the cartridge 15 may be wound around the wick. The aerosol generated in the cartridge 15 may pass through the stick 200 inserted into the aerosol generating device 100 to be delivered to a user.

A lower end of the stick 200 may be inserted into the insertion space S, and an upper end of the stick 200 may be exposed to the outside from the insertion space S. The user may inhale air while holding the upper end of the stick 200 exposed to the outside in his or her mouth. The air may pass through the aerosol generating device 100 to entrain or carry an aerosol and then be delivered to the user.

The battery 11 may supply power to operate at least one of the controller 12, the heater 13, the sensor 14, and the cartridge 15. The battery 11 may supply power required to operate a display, a motor, and the like, installed at the aerosol generating device 100.

The controller 12 may control the overall operation of the aerosol generating device 100. The controller 12 may control the operation of at least one of the battery 11, the heater 13, the sensor 14, and the cartridge 15. The controller 12 may control the operation of the display, the motor, and the like, installed at the aerosol generating device 100. The controller 12 may check the state of each of the components of the aerosol generating device 100 to determine whether the aerosol generating device 100 is in an operable state.

The sensor 14 may sense a change in the ambient or surrounding electromagnetic field. For example, the sensor 14 may sense a change in the electromagnetic field in the insertion space S. The controller 12 may receive a sensing signal from the sensor 14 to determine the surrounding state of the sensor 14. The controller 12 may control the operation of various components based on the change in the electromagnetic field sensed by the sensor 14.

An electrode 20 may be disposed in the vicinity of the insertion space S. The electrode 20 may heat the insertion space S by dielectric heating. The electrode 20 may generate a high-frequency electric field in the insertion space S. The battery 11 may provide a DC voltage. An oscillator may be supplied with the DC voltage from the battery 11 so as to provide an AC voltage to the electrode 20. The controller 12 may control the operation of the high-frequency electric field.

As the electrode 20 heats the insertion space S, a moisture (or water) content in the stick 200 may be reduced. Moisture contained in the stick 200 may be reduced by vibration and evaporation due to dielectric heating. The stick 200 may be dried. During the dielectric heating, a substance included in the medium, such as glycerin, may not evaporate. Alternatively, during the dielectric heating, the evaporation amount of substance included in the medium, such as glycerin, may be less than the evaporation amount of moisture.

Dielectric heating is a high-frequency heating method using dielectric loss. When an insulating material such as a dielectric material is placed in a high-frequency electric field, the dielectric material may be heated due to dielectric loss. As an alternating electric field alternates, a dipole constituting the dielectric material changes a direction to thereby generate vibration equal to the applied frequency. Due to the vibration, frictional heat of dipoles may be generated in the dielectric material, causing the dielectric material to be heated. The frequency of a dipole may differ according to the applied frequency and the applied voltage. The frequency used may vary according to the material.

Energy lost in the dielectric material may be energy supplied to the dielectric material. Since dielectric heating is caused by dielectric loss, it can be selectively absorbed by those with high dielectric loss to thereby heat only a necessary or desired portion. Each of the dielectric materials may have different dielectric loss. The dielectric dissipation factor of water may be greater than the dielectric dissipation factor of glycerin. In addition, since the relative polarity of water is 1 and the relative polarity of glycerin is 0.812, the relative polarity of a water molecule may be higher than that of glycerin.

Accordingly, in a predetermined frequency region, the moisture content of the stick 200 may be reduced by selectively heating and evaporating moisture contained in the stick 200 while leaving glycerin included in the stick 200.

Thus, even when the stick 200 contains moisture in a humid environment, the stick 200 may be easily dried. In addition, a change in the taste of an aerosol generated from the stick 200 may be prevented, thereby maintaining the taste of the aerosol.

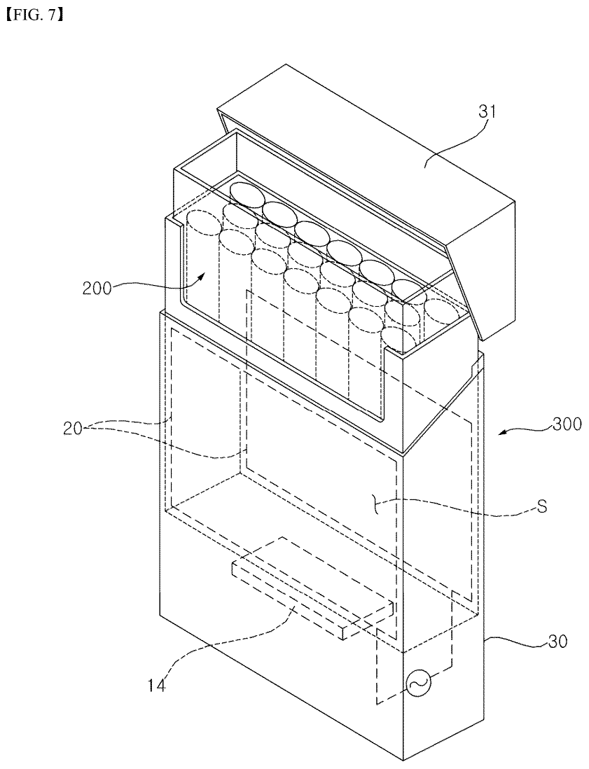

Referring to FIGS. 5 and 6, at least one pair of electrodes 20 may be provided on both or opposite sides with the insertion space S interposed therebetween. The pair of electrodes 20 may face each other. The pair of electrodes 20 may be disposed parallel to each other or disposed to be inclined at a predetermined angle. A high-frequency voltage may be applied to the pair of electrodes 20 to allow the pair of electrodes 20 to heat the stick 200 inserted into the insertion space S by dielectric heating. The electrode 20 may face the insertion space S. The electrode 20 may be elongated in an up-and-down direction along the insertion space S. The electrode 20 may have a height substantially corresponding to a height of the insertion space S. Referring to FIGS. 1, 5, and 6, the heater 13 may be disposed at a center of the insertion space S, and the pair of electrodes 20 may be disposed with the heater 13 interposed therebetween. Alternatively, the heater 13 may surround the insertion space S, and the electrode 20 may be disposed adjacent to an outside of the heater 13.

The sensor 14 may be disposed near the insertion space S to face both sides of the insertion space S. The sensor 14 may face the insertion space S. The sensor 14 may sense a change in the surrounding electromagnetic field. For example, the sensor 14 may sense a change in the electromagnetic field in the insertion space S.

The sensor 14 may be a capacitance sensor 14. The sensor 14 may sense a change in the surrounding capacitance to thereby detect a change in the surroundings. The capacitance sensor 14 may be based on one of two sensor technologies: self-capacitance and mutual capacitance. When an object approaches the capacitance sensor 14, or when an object near the capacitance sensor 14 moves or the state changes, a change in self-capacitance or a change in electrode force between separated electrodes may occur.

The sensor 14 may sense the moisture content of the stick 200 inserted into the insertion space S. For example, in the case of the stick 200 inserted into the insertion space S, the amount of moisture contained in the stick 200 may differ according to the extent of use, thereby causing a change in the capacitance sensed by the sensor 14. Thus, the sensor 14 may detect the extent of use of the stick 200 or reuse of the stick 200. To this end, a lookup-table representing capacitance values sensed by the sensor 14 and corresponding changes in moisture content of the stick 200 may be stored in a memory.

The controller 12 may receive a sensing signal from the sensor 14 to determine the surrounding state of the sensor 14. The controller 12 may control the operation of the electrode 20 according to the moisture content of the stick 200 sensed by the sensor 14. When the moisture content of the stick 200 sensed by the sensor 14 is greater than or equal to a reference value, the controller 12 may control the electrode 20 to heat the insertion space S by dielectric heating to make the stick 200 dried.

Referring to FIGS. 6 and 8, the sensor 14 may sense a moisture content of the stick 200 inserted into the insertion space S (S1) to determine whether the moisture content of the stick 200 is greater than or equal to a reference value (S2). When the moisture content of the stick 200 inserted into the insertion space S is greater than or equal to the reference value (Yes in S2), the controller 12 may control the electrode 20 to heat the stick 200 inserted into the insertion space S by dielectric heating so as to reduce the moisture content of the stick 200 (S3). Thereafter, the moisture content of the stick 200 may be sensed again (S1) to determine whether the moisture content of the stick 200 is greater than or equal to the reference value (S2). When the moisture content of the stick 200 is less than the reference value (No in S2), the controller 12 may control the heater 13 to heat the stick 200 to generate an aerosol (S4).

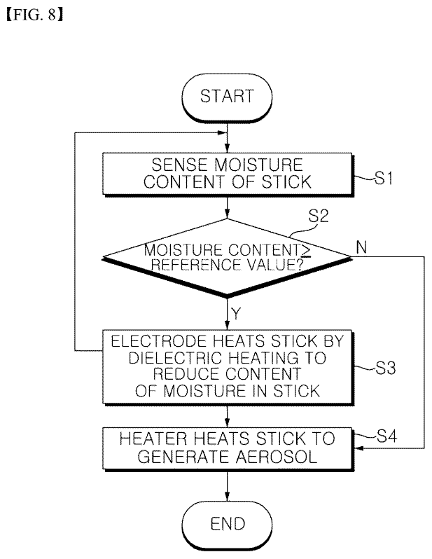

Referring to FIG. 7, the device may be a cigarette case 300. A body 30 of the cigarette case 300 may provide an insertion space S with an open upper portion. The opening of the insertion space S may be covered by a head 31 of the cigarette case 300. The head 31 may be connected to the body 30. The head 31 may be tilted from the body 30 so as to open and close the opening of the insertion space S.

The insertion space S may accommodate a plurality of sticks 200 therein. For example, the insertion space S may receive a total of 20 sticks 200. The cigarette case 300 may include an electrode 20. A pair of electrodes 20 may be disposed on both or opposite sides of the body 30 of the cigarette case 300 with the insertion space S interposed therebetween. The pair of electrodes 20 may face each other. The electrode 20 may be connected to an AC power source to receive a high-frequency voltage. The electrode 20 may heat the insertion space S by dielectric heating, which is the same as that described above, so a description thereof will be omitted. The arrangement of the electrode 20 is not limited to the description above, and various arrangements capable of dielectric heating may be available. The sensor 14 may sense a moisture content of the stick 200 disposed in the insertion space S, which is the same as that described above, so a description thereof will be omitted.

Referring to FIGS. 7 and 8, the cigarette case 300 may not include the heater 13. Therefore, the step S4 may be omitted.

Referring to FIGS. 1 to 8, a device according to one aspect of the present disclosure may include: a body comprising an insertion space; an electrode disposed adjacent to the insertion space; and a controller configured to control the electrode to heat a cigarette inserted into the insertion space by dielectric heating at a predetermined frequency to reduce a moisture content of the cigarette.

According to another aspect of the present disclosure, the electrode may be one of a pair of electrodes respectively, disposed on both sides of the insertion space.

According to another aspect of the present disclosure, the device may further include a sensor disposed near the insertion space. The controller may be configured to determine a moisture content of a cigarette inserted into the insertion space based on a value sensed by the sensor and control the electrode to heat the cigarette by dielectric heating based on the moisture content of the cigarette being greater than or equal to a reference value. The sensor may be a capacitance sensor and the moisture content may be determined based on a capacitance sensed by the sensor. The device may further include a memory configured to store corresponding capacitance values sensed by the sensor and moisture content of the cigarette.

According to another aspect of the present disclosure, the device may further include a resistive heater configured to generate heat to heat the cigarette inserted into the insertion space. The insertion space may have an elongated cylindrical shape to allow a single cigarette to be inserted therein.

According to another aspect of the present disclosure, the electrode may extend along a longitudinal direction of the insertion space to face the insertion space.

According to another aspect of the present disclosure, the device may further include a sensor disposed near the insertion space. The controller may be configured to: determine a moisture content of a cigarette inserted into the insertion space based on a value sensed by the sensor; based on the moisture content of the cigarette being less than a reference value, control the heater to heat the cigarette; and based on the moisture content of the cigarette being greater than or equal to the reference value, control the electrode to heat the insertion space by dielectric heating before the heater heats the cigarette.

According to another aspect of the present disclosure, the heater may protrude from a bottom of the insertion space.

According to another aspect of the present disclosure, the heater may have a cylindrical shape surrounding the insertion space.

According to another aspect of the present disclosure, the device may further include a cartridge mounted to the body and in communication with the insertion space to provide an aerosol to pass through the cigarette inserted in the insertion space.

According to another aspect of the present disclosure, a method for controlling the device may be provided. The method may include: heating the cigarette by dielectric heating at a predetermined frequency using an electrode disposed adjacent to the insertion space to reduce a moisture content of the cigarette.

According to another aspect of the present disclosure, the method may include sensing the moisture content of the cigarette inserted into the insertion space via a sensor; heating the cigarette by dielectric heating using the electrode based on the moisture content of the cigarette being greater than or equal to a reference value to reduce the moisture content of the cigarette; and heating the cigarette via a resistive heater configured to heat the cigarette inserted into the insertion space based on the moisture content of the cigarette being less than the reference value after heating the cigarette by dielectric heating.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. A device comprising:
a body comprising an insertion space;
an electrode disposed adjacent to the insertion space;
a controller configured to control the electrode to heat a cigarette inserted into the insertion space by dielectric heating at a predetermined frequency to reduce a moisture content of the cigarette.

2. The device of claim 1, wherein the electrode is one of a pair of electrodes respectively, disposed on both sides of the insertion space.

3. The device of claim 1
further comprising a sensor disposed near the insertion space,
wherein the controller is configured to:
determine a moisture content of a cigarette inserted into the insertion space based on a value sensed by the sensor, and
control the electrode to heat the cigarette by dielectric heating based on the moisture content of the cigarette being greater than or equal to a reference value,
wherein:
the sensor is a capacitance sensor and the moisture content is determined based on a capacitance sensed by the sensor, and
the device further comprises a memory configured to store corresponding capacitance values sensed by the sensor and moisture content of the cigarette.

4. The device of claim 1, further comprising a resistive heater configured to generate heat to heat the cigarette inserted into the insertion space,
wherein the insertion space has an elongated cylindrical shape to allow a single cigarette to be inserted therein.

5. The device of claim 4, wherein the electrode extends along a longitudinal direction of the insertion space to face the insertion space.

6. The device of claim 4,
further comprising a sensor disposed near the insertion space,
wherein the controller is further configured to:
determine a moisture content of a cigarette inserted into the insertion space based on a value sensed by the sensor;
based on the moisture content of the cigarette being less than a reference value, control the heater to heat the cigarette; and
based on the moisture content of the cigarette being greater than or equal to the reference value, control the electrode to heat the insertion space by dielectric heating before the heater heats the cigarette.

7. The device of claim 4, wherein the heater protrudes from a bottom of the insertion space.

8. The device of claim 4, wherein the heater has a cylindrical shape surrounding the insertion space.

9. The device of claim 4, further comprising a cartridge mounted to the body and in communication with the insertion space to provide an aerosol to pass through the cigarette inserted in the insertion space.

10. A method for controlling a device comprising a body defining an insertion space configured to accommodate a cigarette therein, the method comprising:
heating the cigarette by dielectric heating at a predetermined frequency using an electrode disposed adjacent to the insertion space to reduce a moisture content of the cigarette.

11. The method of claim 10, wherein heating the cigarette comprising:
sensing the moisture content of the cigarette inserted into the insertion space via a sensor;
heating the cigarette by dielectric heating using the electrode based on the moisture content of the cigarette being greater than or equal to a reference value to reduce the moisture content of the cigarette; and
heating the cigarette via a resistive heater configured to heat the cigarette inserted into the insertion space based on the moisture content of the cigarette being less than the reference value after heating the cigarette by dielectric heating.
